(19) United States
(12) Patent Application Publication
(10) Pub. No.: US 2008/0255992 A1
(43) Pub. Date: Oct. 16, 2008

(54) Double recognizing method by means of telephone number and identification code for online credit card transactions over the internet

(76) Inventor: Chung-Yu Lin, Kaohsiung City (TW)

Correspondence Address: BACON & THOMAS, PLLC, 625 SLATERS LANE, FOURTH FLOOR, ALEXANDRIA, VA, 22314-1176, US

(21) Appl. No.: 12/081,328

(22) Filed: Apr. 15, 2008

Related U.S. Application Data
(60) Provisional application No. 60/907,744, filed on Apr. 16, 2007.

(51) Int. Cl. G06Q 40/00

(52) U.S. Cl. 705/44

(57) ABSTRACT

The present invention relates to a “double recognizing method by means of telephone number and identification code for online credit card transactions over the internet,” in which the credit card holder not only registers a “self-chosen code” by himself/herself for VBV (Verified By VISA) or MSC (MasterCard SecureCode) network identity verification but also registers another set of “telephone number and identification code” by himself/herself for serving as an exclusive personal double identity recognizing information for online credit card transactions. The credit card issuing bank registers and stores the set of “telephone number and identification code” on a double recognizing database after checking truth of the related identity certificate provided by the credit card holder. When the credit card issuing bank handles the online credit card transaction of the credit card holder over the network, the credit card issuing bank not only proceeds the check on the “self-chosen code” used in the original VBV or MSC verification system but also performs the double check on the “telephone number and identification code” used in the telecommunications transceiving processor platform of the internal credit card double recognizing computer system, for example by sending out a short message to the credit card holder for requesting him/her to immediately reply by another short message to his/her “telephone number and identification code.”

This application claims the benefit of provisional U.S. Patent Application No. 60/907,744, field Apr. 16, 2007.

### FILED OF THE PRESENT INVENTION

The present invention provides a “double recognizing method by means of telephone number and identification code for online credit card transactions over the Internet” in which, in addition to the existing VBV (Verified By VISA) or MSC (MasterCard SecureCode) network identity verification system, another set of “telephone number and identification code” is also provided by the credit card holder himself/herself directly to the credit card issuing bank over a separate medium, such as a telephone network or e-mail, so as to provide a double identity recognizing function for the credit card holder simultaneously during an online credit card transaction. The addition telephone number and identification code can not only prevent fraudulent credit card transactions resulting from theft of identity information being stolen or loss of a financial card and the like, but acts as a second firewall to prevent fraudulent online credit card transactions using information revealed by keylogging the personal credit card information and “self-chosen code” of the VBV or MSC, incident to a network-connected merchant or credit card issuing bank being illegally intruded by a hacker.

### BACKGROUND OF THE INVENTION

Thanks to prosperity and the prevalence of science and technology, the consuming style and transactional amount of network purchases has already increased greatly, and likely will become the mainstream for commodity selling in the future. The most common current payment method used in network commodity transactions is the online credit card transaction. A block diagram of the conventional transactional procedure is shown in FIG. 1. According to the procedure shown in FIG. 1, when the credit card holder 100 proceeds with an online credit card transaction over the network W, the network shop or merchant 1 will use the credit card number information input by the credit card holder 100 via the commodity webpage to ask the credit card issuing bank 2 for a “request for authorization” via the network W. Upon verifying the credit information, such as credit card number, available credit amount, and the like with respect to the credit card holder 100, by means of the computer information processing system in the credit card issuing bank 2, the system will reply with an instruction of “authorization is granted” back to the network shop 1 and display a flag of “successful online credit card transaction” on the webpage thereof. Conversely, the system will reply with an instruction of “authorization is not granted” back to the network shop 1 and display a flag of “failed online credit card transaction” on the web page thereof if the credit card information cannot be verified or does not support the transaction.

In the operational procedure of the foregoing conventional online credit card transaction over a network, owing to lack of signature confirmation by the credit card holder 100 himself/herself, the actual identity of the credit card holder 100 cannot be confirmed or authenticated so that the credit card holder 100 can refuse such transaction after receiving the related bill by submitting a “deny transaction” claim to the credit card issuing bank 2. In that case, the credit card issuing bank 2 will temporarily withhold payment to said network shop 1 and get into an arbitration procedure for the transaction. At this moment, the network shop 1 is obliged to provide all variety of supporting evidential information, such as transaction record, commodity voucher or even tape-recording of the dealing telephone in order to provide evidence for the arbitration. The network shop 1 will not be paid unless enough such evidence can be provided during the arbitration. While the arbitration procedure can help avoid harm to the card holder from fraudulent online credit card transactions, annoyance and delay of payment collecting procedure is incurred for both of the credit card issuing bank 2 and network shop 1. In addition, some malignant network purchasers might take advantage of the arbitration procedure by using a “deny transaction” claim to undertake financial fraud by falsely claiming that no such online credit card transaction had ever happened. This has become a great obstacle in the development of the online credit card transactions over the network.

In view of the drawbacks resulting from lack of signature confirmation by the credit card holder 100 himself/herself for the online credit card transaction over the network, both of the Visa International Service Association (VISA) and MasterCard Incorporated (MasterCard), which are the international organizations for issuing credit cards, provided the “VBV verification for short of Verified by Visa” and “MSC verification for short of MasterCard SecureCode” respectively as the mechanism of the identity verification over network. In these procedures, the credit card holder 100 first registers a “self-chosen code” to the credit card issuing bank 20. For each online credit card transaction, the credit card holder 100 is first requested to input the “self-chosen code” into the verification system of the VBV or MSC for identity confirmation by such verification system before the transaction can proceed. The associated operational procedure is shown as in the FIG. 2, wherein the credit card holder 100 first inputs the information of card number into the webpage of the VBV/MSC mechanism network shop 10 over the network W when he/she get into there for online credit card transaction Then, the VBV/MSC identity verification webpage 30 of the credit card issuing bank 20 will pop up for asking said credit card holder 100 input his/her “self-chosen code” of VBV/MSC identity verification in the code field 31 thereon for identity verification, so that the internal computer information system of the credit card issuing bank 20 can perform matching comparison with such “self-chosen code” input at that time. Normally, if “verification is valid” in the comparison result, which means the current consumer is the authentic credit card holder 100 himself/herself, the authorization procedure of the credit card issuing bank 20 will be intelligently activated for checking the information of the credit card number and available credit amount, and the system will reply with an instruction of “authorization is granted” back to the VBV/MSC mechanism network shop 10 and display a flag of “successful online credit card transaction” on the webpage thereof. Conversely, if “verification is invalid” in the comparison result, which means the current consumer is not the authentic credit card holder 100 himself/herself or the “self-chosen code” input is incorrect and must be re-input, the authorization procedure of the credit card issuing bank 20 will be not activated and the system will reply with an instruction of “authorization is not granted” back to the VBV/MSC mechanism network shop 10 and display a flag of “failed online credit card transaction” on the webpage thereof.

Accordingly, both of the VISA and MasterCard international organizations actively promote by constantly declaring and trying to convince network purchasers that he/she should go to the dealing credit card issuing bank 20 for registration of the “self-chosen code” used in VBV or MSC identity verification so that the credit card holder 100 has further security protection over online credit card transaction to avoid suffering from fraudulent on-line credit card transactions due to his/her credit card number or information being illegally keylogged as long as the “self-chosen code” is additionally applied in the VBV/MSC mechanism network shop 10 for online credit card transaction. However, the canvassing address from both of the VISA and MasterCard international organizations to the managers of the network shop went even further; The appealing address said: “As long as your shop participates and become a member of the VBV/MSC mechanism network shop 10, in the future, every online credit card transaction accomplished on your webpage will let you have the result to disable the justification of the “deny transaction” claim from the consumer in an arbitration procedure because the consumer cannot deny the online credit card transaction once the VBV or MSC identity verification system has a record of inputting his/her “self-chosen code” by himself/herself used in VBV or MSC identity verification before the transaction proceeds; Therefore, the collecting payment for a commodity or outlay will not be delayed.” This declaration concerning security and absolute protection over online credit card transactions for the consumers also had a different connotation. Owing to the additional procedure of the VBV or MSC identity verification, the credit card issuing bank 20 and VBV/MSC mechanism network shop 10 could unilaterally declare the authenticity of the credit card holder 100 himself/herself even when the transaction is a fraudulent on-line credit card transaction due to his/her credit card number or information being illegally keylogged so that the credit card holder 100 cannot claim “deny transaction” in accordance with former cases, because the VBV or MSC identity verification system has the record of inputting his/her “self-chosen code” used in VBV or MSC identity verification. Thus, the credit card holder 100 has to suffer from injustice and obediently pay the money in consequence of dismissal or failure in the arbitration.

Recently, the internal computer information system of the credit card issuing bank 20 or the mainframe system of the VBV/MSC mechanism network shop 10 has been increasing subjected to illegal intruded by the hackers, or the computer of the consuming credit card holder 100 has been illegally keylogged by hackers. This happened, for example, in March of 2007 to The TJX Companies, Inc., which is the largest off-price apparel and home fashions retailer in both the United States and the world, including A.J. Wright, Bob's Stores, HomeGoods, T.J. Maxx, HomeSense, Winners and TK Maxx chains with nearly 2,500 stores worldwide and annual revenue over 16 billion US dollars. Prior to this incident, from July of 2005 to December of 2006 for a period of 18 months, the 45 million records of customer information in the credit card system were stolen by illegal download. When the computer of the consuming credit card holder 100 is illegally keylogged by the hackers, the original “self-chosen code” of himself/herself used in VBV/MSC identity verification will be divulged by keylogging since it is combined with his/her computer record. Since the incident of huge records of information in the credit card of the customers being stolen by illegally download happened in the TJX Companies, Inc., the president and CEO Carol M. Meyrowitz could only, in an open letter on her entrepreneurial website addressed to her customers, individually express her regrets for the inconvenience caused by the incident and promise to provide a safer shopping environment, rather than providing any compensation for the incident.

Therefore, without a guarantee that the customer information in the credit card will not be divulged from the network shop 10 or credit card issuing bank 20, the request for credit card holders to register a “self-chosen code” for identity verification used in VBV/MSC mechanism as a transactional basis, only benefits the shop and not the cardholder by assisting the shop in collecting payment. The original rights and interests of the consumers is not protected, so that the consumer is obliged to bear for himself/herself the risk in fraudulent online credit card transaction in consequence of relatively disadvantaged status. Therefore, how to protect the right and interest of the customer for avoidance of risk in fraudulent on-line credit card transactions becomes urgent and necessary.

### SUMMARY OF THE INVENTION

The primary object of the present invention is to provide a fraud transaction preventive method in the financial service system by means of telephone number and identification code which is provided directly by a consumer during a transaction in a manner separate from the identity and account information, for example, by a telephone, whereby, the financial account holder provides a set of “telephone number and identification codes” by himself/herself for serving as exclusive recognizing information to the dealing financial institution in which the account is opened, and the set of “telephone number and identification code” is registered and stored in an internal computer database of the dealing financial institution after related identity certificate information of the financial account holder has been checked by the dealing financial institution. When a financial institution handles various financial services such as deposit/withdraw money at a teller, financial card transactions on an ATM, transfers between accounts and remittances via a network bank and the like for the financial account holder, not only will the original account number, security code, dynamic code card be checked, but also the “telephone number and identification code” currently input by the financial account holder will be checked by matching comparison with the telephone number and code originally registered and stored in the internal computer database of the dealing financial institution for determining whether they are identically matched each other so that the bank can simultaneously assure such transaction service is really done for the authentic financial account holder, so as to avoid any thieving withdrawal or fraudulent withdrawal incurred by the identity information being stolen, loss of financial card or revealing of a security code and the like.

The other object of the present invention is to provide a fraud transaction preventive method in the financial service system by means of telephone number and identification code which is provided directly by a consumer during a transaction in a manner separate from the identity and account information, for example, by a telephone, whereby the financial account holder provides a set of “telephone number and identification code” by himself/herself for serving as exclusive recognizing information to the dealing financial institution of which the account opened, and said set of “telephone number and identification code” is registered and stored in the internal computer database of the dealing financial institution after related identity certificate information of said financial account holder has been checked by the dealing financial institution. When a financial institution handles a credit card transaction at a clerk or an online credit transaction for the financial account holder, not only will the original account number, security code, dynamic code card be checked, but also the “telephone number and identification code” currently input by the financial account holder will be checked by matching comparison with that originally registered and stored in the internal computer database of the dealing financial institution for determining whether they are identically matched with each other so that the bank can simultaneously assure such transaction service is really done for the authentic financial account holder, so as to avoid any fraudulent credit card transaction resulting from the identity information being stolen or loss of a financial card and the like.

### BRIEF DESCRIPTION OF THE DRAWINGS

FIG. 1 is a block diagram of an operational procedure for a conventional online credit card transaction over the Internet

FIG. 2 is a block diagram of an operational procedure for a conventional online credit card transaction over the Internet with a VBV/MSC verification mechanism.

FIG. 3 is a flowchart of operational steps in a first preferred embodiment of the present invention.

FIG. 4 is a block diagram of an operational procedure in the first preferred embodiment of the present invention.

FIG. 5 is a first block diagram of an operational procedure in the preferred embodiment of the present invention.

FIG. 6 is a second block diagram of an operational procedure in the first preferred embodiment of the present invention.

FIG. 7 is a flowchart of operational steps in another preferred exemplary embodiment for the present invention.

FIG. 8 is the block diagram of an operational procedure in another preferred embodiment of the present invention.

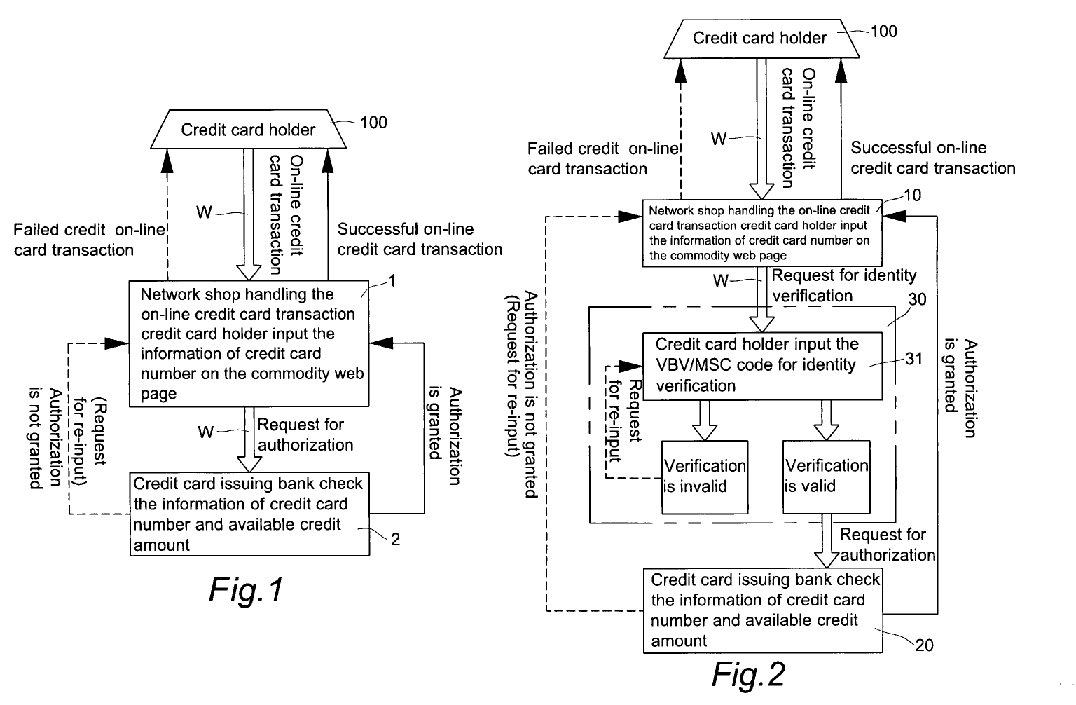

### DETAILED DESCRIPTION OF THE PREFERRED EMBODIMENTS

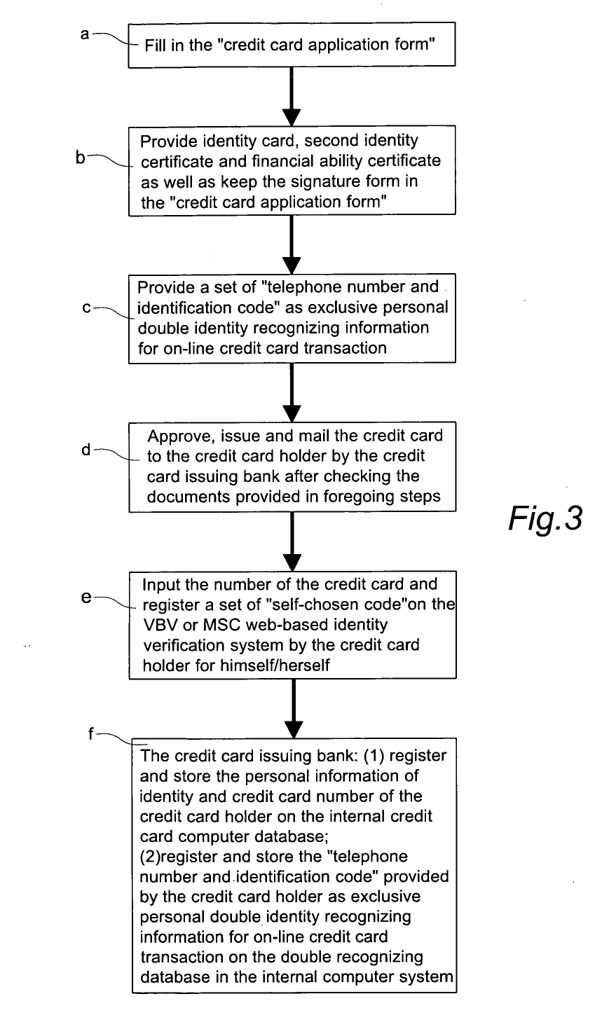

As shown in the FIG. 3 through FIG. 5, “a double recognizing method by means of telephone number and identification code for on-line credit card transaction over the Internet” according to the present invention includes the following operation steps:

a. Fill in the “credit card application form” provided by the credit card issuing bank 20;

b. Keep the signature form in the “credit card application form” as well as provide identity card, second identity certificate and financial ability certificate to the credit card issuing bank 20 for creating a file as copy;

c. Provide a set of “telephone number and identification code” to the credit card issuing bank 20 by the applicant of the credit card for serving as exclusive personal double identity recognizing information for online credit card transaction;

d. Approve, issue and mail the credit card to the credit card holder 100 by the credit card issuing bank 20 after checking the related identity certificate provided in foregoing steps a and b;

e. Input the number of the credit card and register a set of “self-chosen code” with VBV or MSC web-based identity verification function on the VBV or MSC web-based identity verification system of the credit card issuing bank 20 by the credit card holder 100 who received the credit card for himself/herself; and

f. The credit card issuing bank 20: (1) register and store the personal information of identity and credit card number of the credit card holder 100 on the internal credit card computer database; (2) additionally register and store the set of “telephone number and identification code” provided by the credit card holder 100 for serving as an exclusive personal double identity recognizing information for on-line credit card transactions on a separate double recognizing database 23 in the internal credit card double recognizing computer system 21.

By means of all the foregoing operational steps, when handling the online credit card transaction for the credit card holder 100 over the network, the credit card issuing bank 20 not only proceeds to check the “self-chosen code” used in the original VBV or MSC verification system, but also performs a double check on the “telephone number and identification code” used in the telecommunications transceiving processor platform 22 of the internal credit card double recognizing computer system 21, thereupon sending out a short message to the credit card holder 100 for requesting him/her to immediately reply with his/her “telephone number and identification code” as an exclusive personal double identity recognizing information for online credit card transactions in the form of a short message by his/her cellular phone 101 over the telecommunications network T so as to do matching comparison with the “telephone number and identification code” previously registered and stored in the double recognizing database 23 of the credit card issuing bank 20 for determining whether they are identically matched each other and thereby provide a double proof and recognizing mechanism for the identity verification of the credit card holder 100 in online credit card transaction over the network.

The “telephone number” in step c can be a household telephone number of the credit card holder 100, a company web-linked telephone number, a personal cellular phone number, a web-linked telephone number with country code and area code, or a cellular phone number with country code. In addition, the “identification code” can be any character, number, symbol or any combination thereof input via computer keyboard, which can be arbitrarily revised or changed at any time by the original credit card holder 100 personally under the stipulated procedure and rules of the credit card issuing bank 20 after providing for registration.

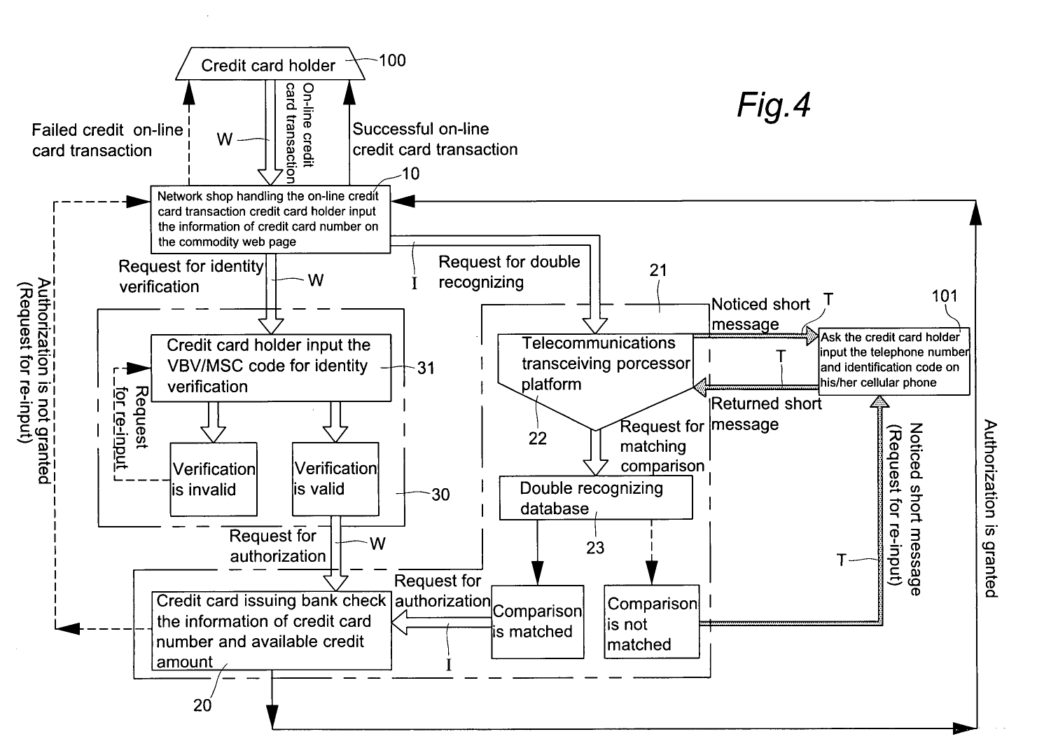

Moreover, the internal credit card double recognizing computer system 21, which is connected with the VBV/MSC mechanism network shop 10 via a second network I, in the step f is independently disposed out of the other internal financial computer systems of the credit card issuing bank 20 having an internal telecommunications transceiving processor platform 22 with the function of automatically sending out a short message to ask the credit card holder 100 to reply his/her “telephone number and identification code” in the form of short message by his/her cellular phone 101 after receiving the information of the credit card number over the telecommunications network T (as shown in the FIG. 4).

Please further refer to the FIG. 4, which is a block diagram of the operational procedure in a first preferred embodiment for the present invention. The credit card holder 100 first inputs the information of credit card number into the webpage of the VBV/MSC mechanism network shop 10 over the network W when he/she selects the webpage for an online credit card transaction. At the same time that the VBV/MSC identity verification webpage 30 of the credit card issuing bank 20 being pops up, the internal credit card double recognizing computer system 21 in the credit card issuing bank 20 is simultaneously activated for proceeding with double recognizing request of the network identity verification. The operational procedure of the tandem system is illustrated as below:

First, the credit card holder 100 inputs a “self-chosen code” required for VBV/MSC identity verification in the code field 31 of the VBV/MSC identity verification webpage 30 so that the internal computer information system of the credit card issuing bank 20 can perform matching comparison for identity verification. If “verification is valid” in the comparison result, which means the current consumer might be the authentic credit card holder 100 himself/herself and the credit card holder 100 has already passed the VBV/MSC network identity verification (that is the first threshold of identity verification), the instruction of “verification is valid” will be transmitted to the internal credit card computer processing system of the credit card issuing bank 20 via network W.

Meanwhile, the telecommunications transceiving processor platform 22 of the internal credit card double recognizing computer system 21 will send out a short message via network W to the cellular phone of credit card holder 101 for notification that there is an online credit card transaction with the amount of money indicated together with a request for asking the credit card holder 100 immediately input and reply his/her “telephone number and identification code” as exclusive personal double identity recognizing information for online credit card transaction; The credit card holder 100 will send out a “request for matching comparison” to the double recognizing database 23 of the internal credit card double recognizing computer system 21 therein after replying his/her “telephone number and identification code”, which being requested and only known by himself/herself, If a set of “telephone number and identification code” is found to be identically matched with that originally registered and stored in the double recognizing database 23, the internal credit card double recognizing computer system 21 will flag an instruction of “comparison is matched”, which also means the current consumer is the authentic credit card holder 100 himself/herself and the credit card holder 100 already passed the “telephone number and identification code” identity verification (that is the second threshold of identity verification), Besides, the instruction of the “comparison is matched” will be transmitted to the internal credit card computer processing system of the credit card issuing bank 20 via second network I.

The credit card issuing bank 20 will receive each of a “request for authorization” from the VBV/MSC identity verification web page 30 and the double recognizing database 23 respectively. When the internal credit card computer processing system thereof has received both instructions of “verification is valid” from the VBV/MSC identity verification web page 30 and “comparison is matched” from the double recognizing database 23 at the same time, the “request for authorization” is intelligently activated for checking the information of the credit card number and available credit amount of the credit card holder 100. The system will reply with an instruction of “authorization is granted” back to the VBV/MSC mechanism network shop 10 and display a flag of “successful online credit card transaction” on the webpage thereof if informational terms are justifiable. Conversely, if the number information of the credit card or the available credit amount is not enough, the system will reply an instruction of “authorization is not granted” back to the VBV/MSC mechanism network shop 10 and display a flag of “failed online credit card transaction” on the webpage thereof. If the internal credit card computer processing system of the credit card issuing bank 20 only receives one of an instruction of “verification is valid” from the VBV/MSC identity verification web page 30 or “comparison is matched” from the double recognizing database 23 instead of both, the “request for authorization” will be not be given by the credit card issuing bank 20, and the system will also reply an instruction of “authorization is not granted” back to said VBV/MSC mechanism network shop 10 and display a flag of “failed online credit card transaction” on the webpage thereof.

In the foregoing operational procedure, in case the credit card holder 100 is reluctant to reply his/her “telephone number and identification code” as exclusive personal double identity recognizing information for online credit card transaction on his/her cellular phone 101, the telecommunications transceiving processor platform 22 in the internal credit card double recognizing computer system 21 will not only be unable proceed further matching comparison with that in the double recognizing database 23 but also be interrupted in consequence of no resulting instruction for matching comparison. Thus, the “request for authorization” procedure will not proceed in the credit card issuing bank 20 and results in the failure of such online credit card transaction eventually. Alternatively, in case the “telephone number and identification code” input by the credit card holder 100 is incorrect, the result of the matching comparison via the telecommunications transceiving processor platform 22 with that of the double recognizing database 23 will be “comparison is not matched.” Similarly, the “request for authorization” procedure will not proceed in the credit card issuing bank 20 and results in the failure of such online credit card transaction eventually. Therefore, even if both of the credit card information and the “self-chosen code” used in the VBV/MSC identity verification are illegally divulged, the credit card holder 100 shall not worry about suffering from fraudulent online credit card transactions because the “telephone number” and “identification code”, which serves as the second threshold of identity verification, are only known by the credit card holder 100 himself/herself. Nobody other than the actual card holder, including a hacker evildoer, can smoothly achieve the goal of a fraudulent online credit card transaction due to unavailability of the “telephone number” and “identification code” to the hacker. Meanwhile, the VBV/MSC mechanism network shop 10 or the credit card issuing bank 20 can avoid the annoyance and loss from “deny transaction” claim incurred by the fraudulent online credit card transaction.

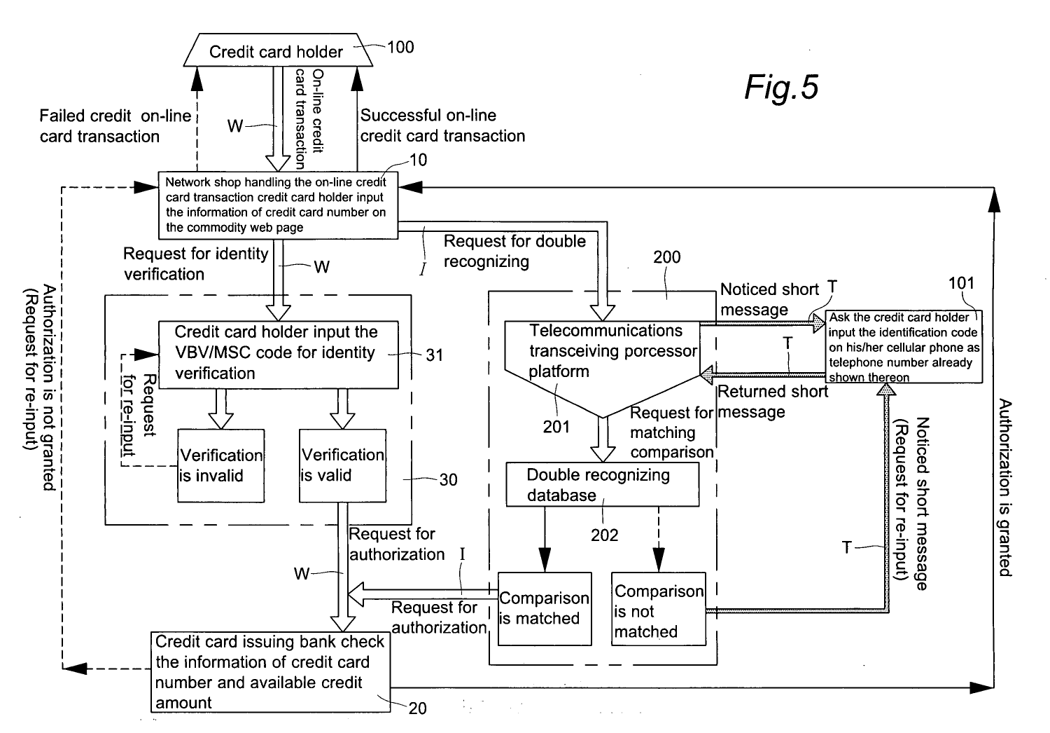

As further shown in the FIGS. 3 and 5, in the foregoing step f, the internal credit card double recognizing computer system 21 in the credit card issuing bank 20 can be further adapted into an external credit card double recognizing computer system 200 which is outside of the credit card issuing bank 20 and connecting with second network I, so that it also has a double recognizing database 202 and telecommunications transceiving processor platform 201 disposed internally with a communication function of sending out short message to the cellular phone of credit card holder 101 and asking the credit card holder 100 to reply his/her “telephone number and identification code” immediately after receiving related information of credit card from the credit card holder 100 over the telecommunications network T. Additionally, for the purpose of ease of operation and expediting reply of the short message, the content text of the issuing short message from the telecommunications transceiving processor platform 201 can initiatively display the “telephone number” registered by the credit card holder 100 and ask the credit card holder 100 to only input the “identification code” registered into his/her cellular phone 101 for reply (as shown in the figure notation 101 of the FIG. 5). Thereby, such flexible operation mode can also achieve the effect of matching comparison with double recognizing database 202. Moreover, since the external credit card double recognizing computer system 200 is external to and separate from the internal computer system in the credit card issuing bank 20 and connects over second network I instead of common network W, it becomes a completely discrete unit with safety protection for hacker intrusion so that the unobtainable “telephone number and identification code” forms a defensive blockade to prevent the hacker from achieving the goal of fraudulent online credit card transaction even if the hacker has successfully stolen number information about the credit card and the “self-chosen code” in VBV/MSC identity verification of the credit card holder 100 by illegal intrusion. This is analogous to the principle that when a burglar intends to enter a house, he cannot achieve his goal without the key to the second inner door even he already has the key of the first outer door.

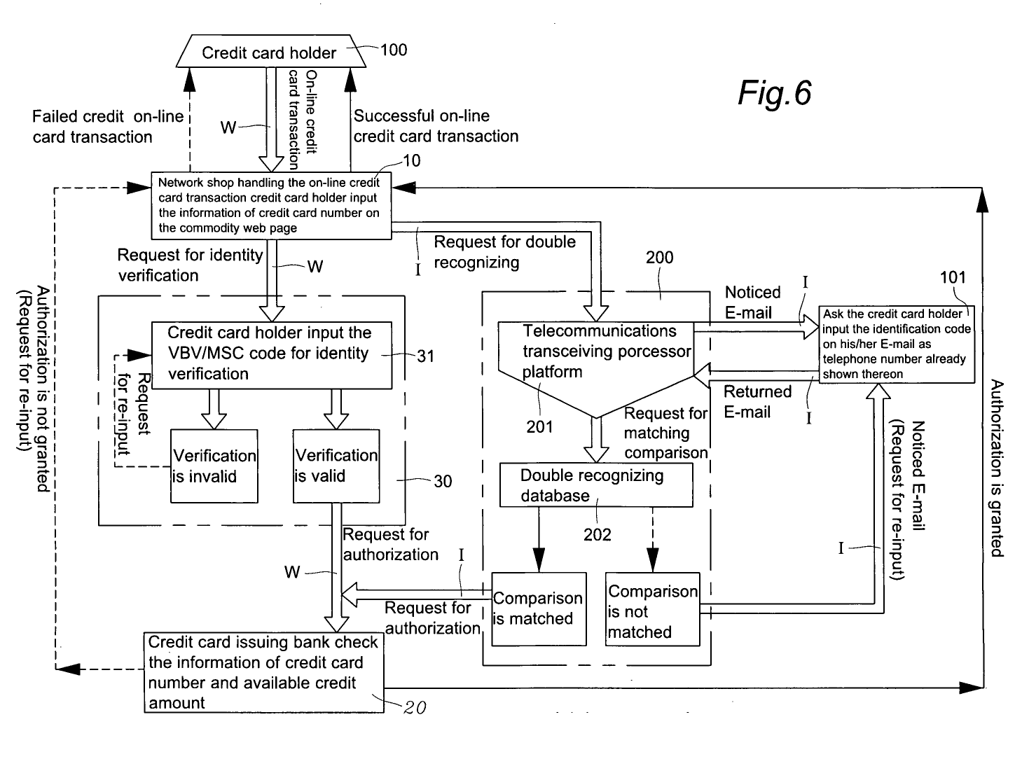

Please further refer to the FIG. 6, wherein, the notification mode of the telecommunications transceiving processor platform 201 can be further adapted into email or voice mode to inform and ask the credit card holder 100 to reply with his/her registered “telephone number and identification code.” Similarly, the content text of the issuing short message from the telecommunications transceiving processor platform 201 can initially also display the “telephone number” exactly registered by the credit card holder 100 in the double recognizing database 202.

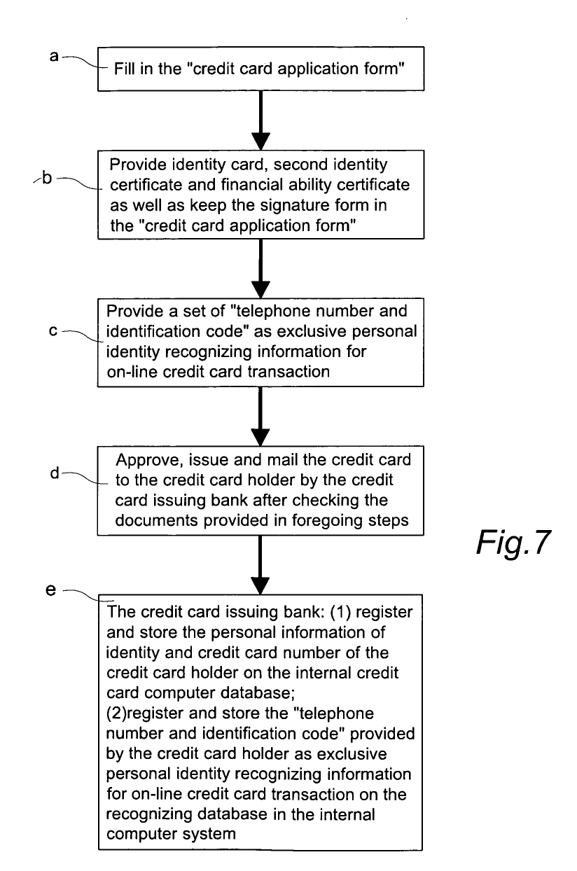

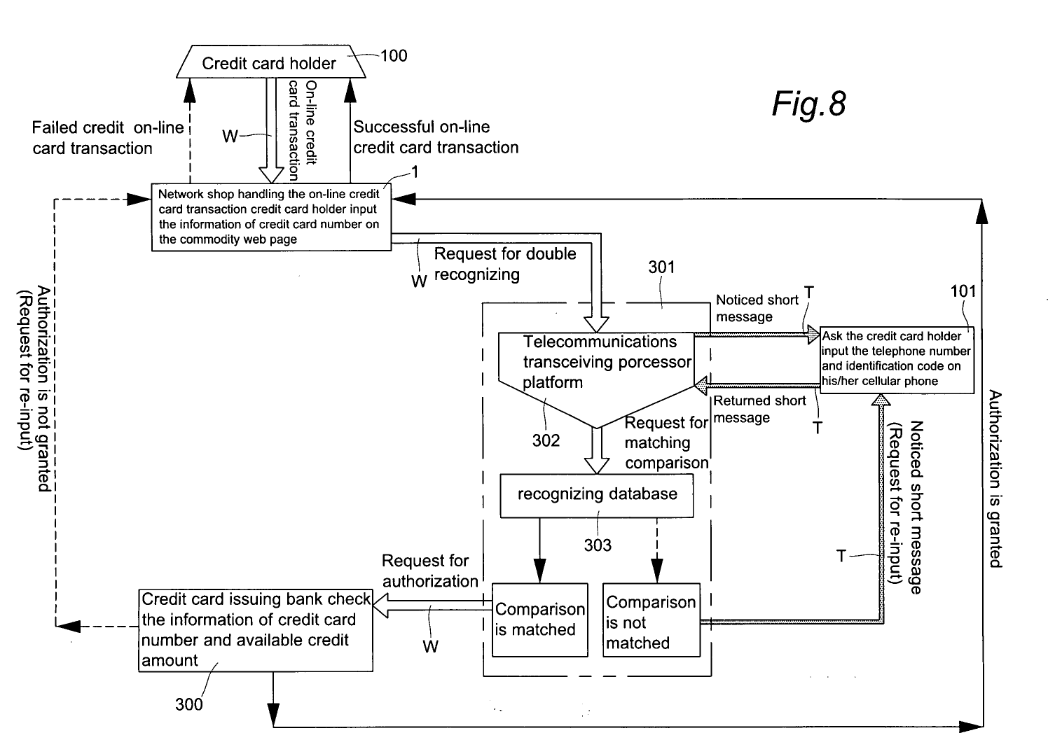

As shown in the FIG. 7 and FIG. 8, “a double recognizing method by means of telephone number and identification code for on-line credit card transaction over the internet” in another preferred exemplary embodiment of the present invention has the following operation steps:

a. Fill in the “credit card application form” provided by the credit card issuing bank 300;

b. Keep the signature form in the “credit card application form” as well as provide an identity card, second identity certificate and financial ability certificate to the credit card issuing bank 300 for creating a file as copy;

c. Provide a set of “telephone number and identification code” to the credit card issuing bank 300 by the applicant of the credit card for serving as an exclusive personal identity recognizing information for on-line credit card transactions;

d. Approve, issue and mail the credit card to the credit card holder 100 by the credit card issuing bank 300 after checking the related identity certificate provided in foregoing steps a and b; and

e. The credit card issuing bank 300: (1) register and store the personal information of identity and credit card number of the credit card holder 100 on the internal credit card computer database; (2) additionally register and store the set of “telephone number and identification code” provided by the credit card holder 100 for serving as exclusive personal identity recognizing information for on-line credit card transaction on the recognizing database 303 in the internal credit card recognizing computer system 301.

By means of the foregoing operational steps, when handling the online credit card transaction for the credit card holder 100 over the network, the credit card issuing bank 300 not only proceeds with the check on the related identity certificate of the credit card holder 100 but also performs the double check on the “telephone number and identification code” used in the telecommunications transceiving processor platform 302 of the internal credit card recognizing computer system 301, by sending out a short message to the credit card holder 100 for requesting him/her to immediately reply to his/her “telephone number and identification code” as exclusive personal double identity recognizing information for an online credit card transaction, in the form of a short message over the telecommunications network T, so as to do matching comparison with the “telephone number and identification code” previously registered and stored in the recognizing database 303 of the credit card issuing bank 300 for determining whether they are identically matched each other such that becoming a basis for the identity verification of the credit card holder 100 in online credit card transaction over the network.

As shown in FIG. 8, which is a block diagram of an operational procedure in another preferred embodiment of “a double recognizing method by means of telephone number and identification code for on-line credit card transaction over the internet” for the present invention, when the credit card holder 100 selects the network shop 1 over network W for an online credit card transaction, in case the credit card holder 100 is reluctant to reply his/her “telephone number and identification code” as exclusive personal double identity recognizing information for online credit card transaction on his/her cellular phone101, the telecommunications transceiving processor platform 302 in the internal credit card double recognizing computer system 301 will not only be unable proceed with further matching comparison using the double recognizing database 303 but also will be interrupted in consequence of no resulting instruction from the matching comparison. Thus, the “request for authorization” procedure will not proceed in the credit card issuing bank 300 and results in the failure of such online credit card transaction eventually. Alterantively, in case the “telephone number and identification code” input by the credit card holder 100 is incorrect, the result of the matching comparison via the telecommunications transceiving processor platform 302 with that of the double recognizing database 303 will be “comparison is not matched.” Similarly, the “request for authorization” procedure will not proceed in the credit card issuing bank 300 and results in the failure of such online credit card transaction eventually. Therefore, even if the credit card information is illegally divulged by someone else or a hacker, the credit card holder 100 does not have to worry about suffering from a fraudulent online credit card transaction because the “telephone number” and “identification code”, which serves as the second threshold of identity verification, are only known by the credit card holder 100 himself/herself. Nobody else, such as a hacker evildoer, can smoothly achieve the goal of a fraudulent online credit card transaction due to unavailable to the “telephone number” and “identification code.” Meanwhile, the network shop I or the credit card issuing bank 300 can avoid annoyance and loss from a “deny transaction” claim incurred by the fraudulent online credit card transaction. Thus, since there is no “self-chosen code” of the VBV or MSC identity verification in this exemplary embodiment, the drawback of fraudulent online credit card transaction incurred from the “self-chosen code” being divulged by keylogging can be eliminated.

In conclusion, the “telephone number and identification code” adopted by the present invention serves as a second safety protection mechanism of the online credit card transaction, not only to ensure that an online credit card transaction between the network shop 1 and the consuming credit card holder 100 is more safe but also to prevent the personal credit card information and “self-chosen code” in VBV or MSC from keylogging or fraudulent on-line credit card transaction incurred by the illegal intrusion into the computer system of the network shop 1 or credit card issuing bank 2 by a hacker. As a result, the criminal behavior of the fraud of the on-line credit card transaction can be effectively precluded. Besides, the present invention can also be applied on the other online credit card commodity transaction systems, which do not require the consumer to sign the associated credit card billing in his/her presence of venue, such as a television purchase channel, mail purchase and the like. Therefore, the present invention really possesses a high degree of novelty and practical industrial application.

The advantages of adopting “telephone number” and “identification code” in the present invention, which serve as a second safety protection mechanism of the online credit card transaction, has been descriptively disclosed in the patent application of “A method of searching a specific computer IP address of Internet networks using several specific telephone number with numbers in series which are arranged and assembled in sequence and coded with identification codes” submitted to the Taiwan Intellectual Property Office with filing number 93112373 filed on Apr. 30, 2004, by the inventor of the present invention; Besides, a website www.2udg.com, which was established in accordance with disclosed technology for the practical embodiment of the patent application by the inventor of the present invention, has run smoothly up to now and proves to have entirely achieved the anticipated effect. However, the computer hardware and software technology thereabout, which is publicly known to technician who is skilful in such technology and not associated with the object of the present invention, will not be described here in redundant manner.

What is claimed is:

1. A method of providing additional verification for credit card transactions using a telephone number and identification code directly provided by the card holder over a separate medium during a transaction, comprising the steps of:
a party to the transaction other than the cardholder submitting credit card information over a first medium to a credit card issuing bank for verification using a credit card information database;
the credit card issuing bank requesting at least the identification code directly from the cardholder over the separate medium rather than over the first medium and verifying the telephone number and identification code using a database other than the credit card information database.

2. A method as claimed in claim 1, wherein the separate medium is a telephone network.

3. A method as claimed in claim 2, wherein the network is a cellular network.

4. A method as claimed in claim 1, wherein the separate medium is e-mail.

5. A method as claimed in claim 1, wherein said identification code is a password and a message is sent to the telephone number over the separate medium, said message requesting that the credit card holder respond by entering a password and sending the password back over the first medium in order to verify said telephone number and identification code.

6. A method of providing additional verification for credit card transactions using a telephone number and identification code directly provided by the card holder over a separate medium during a transaction, comprising the steps of:
a. filling in the “credit card application form” provided by the credit card issuing bank;
b. keeping a signature form in the “credit card application form” as well as providing an identity card, second identity certificate and financial ability certificate to the credit card issuing bank for creating a file as a copy;
c. providing a set of “telephone number and identification code” to the credit card issuing bank by the applicant of the credit card for serving as an exclusive personal double identity recognizing information for an online credit card transaction;
d. approving, issuing and mailing the credit card to the credit card holder by the credit card issuing bank after checking the related identity certificate provided in the foregoing steps a and b; and
e. the credit card issuing bank: (1) registering and storing the personal information of identity and credit card number of the credit card holder on the internal credit card computer database; (2) additionally registering and storing the set of “telephone number and identification code” provided by the credit card holder for serving as exclusive personal double identity recognizing information for an on-line credit card transaction on the double recognizing database in the internal credit card double recognizing computer system;
wherein by means of steps a to e, when handling the credit card holder online credit card transaction over the network, the credit card issuing bank not only proceeding with a check on the credit card issuing bank not only proceeds with a check on at least one of (i) the related identity certificate of the credit card holder and (ii) a “self-chosen code” used in an original VBV or MSC verification system, but also (iii) performs a double check on the “telephone number and identification code” used in a telecommunications transceiving processor platform of the internal credit card double recognizing computer system, by sending out a short message to the credit card holder requesting him/her to immediately reply to his/her “telephone number and identification code” as exclusive personal double identity recognizing information for the online credit card transaction in the form of a short message over the telecommunications network to enable matching comparison with the “telephone number and identification code” previously registered and stored in the double recognizing database of the credit card issuing bank for determining whether they are identically matched each other such that a double proof and recognizing mechanism for the identity verification of the credit card holder during an online credit card transaction is carried out over the network.

7. The method as recited in claim 6, wherein the credit card issuing bank proceeds with the check on the self-chosen code, said method further comprising the step, before step e, of inputting the number of the credit card and registering the “self-chosen code” with VBV or MSC web-based identity verification function on the VBV or MSC web-based identity verification system of the credit card issuing bank by the credit card holder, who received the credit card, for himself/herself.

8. The method as recited in the claim 6, wherein articles, provisions and clauses stipulated in the form or content of the “credit card application form” together with associated identity certificate and signature form described in the step a and step b are all formulated by each credit card issuing bank itself in accordance with the domestic laws of a country of the bank.

9. The method as recited in claim 6, wherein said “telephone number” in step c is a household telephone number of the credit card holder, company web-linked telephone number, personal cellular phone number, web-linked telephone number with country code and area code, or cellular phone number with country code.

10. The method as recited in the claim 6, wherein said “identification code” in step c is any character, number, symbol or any combination thereof input via a computer keyboard, which can be arbitrarily revised or changed at any time by the original credit card holder personally under a stipulated procedure and rules of the credit card issuing bank after providing for registration.

11. The method as recited in the claim 6, wherein said internal credit card double recognizing computer system is connected with a VBV/MSC mechanism network shop via a second network, and step e is independently carried out by the other internal financial computer systems of the credit card issuing bank having an internal telecommunications transceiving processor platform with a function of automatically sending out a short message to ask the credit card holder to reply his/her “telephone number and identification code” in form of short message by his/her cellular phone after receiving the information of the credit card number over the telecommunications network.

12. The method as recited in the claim 6, wherein, in the foregoing step e, said internal credit card double recognizing computer system in the credit card issuing bank is further adapted into an external credit card double recognizing computer system, which is outside of the credit card issuing bank and connected with a second network, so that it has a double recognizing database and telecommunications transceiving processor platform disposed internally with a communication function of sending out a short message to the cellular phone of credit card holder and asking the credit card holder to reply to his/her “telephone number and identification code” immediately after receiving related information about the credit card from the credit card holder over the telecommunications network.

13. The method as recited in the claim 6, wherein the content text of the issuing short message from said telecommunications transceiving processor platform initiatively displays the “telephone number” registered by the credit card holder and only asks 4 credit card holder to input the “identification code” registered into his/her cellular phone for reply.

14. The method as recited in the claim 6, wherein the notification mode of the telecommunications transceiving processor platform is further adapted to use an email or voice mode to inform and ask the credit card holder to reply to his/her registered “telephone number and identification code.”

15. The method as recited in claim 6, wherein the content text of the issuing short message from said telecommunications transceiving processor platform also displays the “telephone number” exactly as registered by the credit card holder in the double recognizing database.
